(19) United States
(12) Patent Application Publication
(10) Pub. No.: US 2024/0248378 A1
(43) Pub. Date: Jul. 25, 2024

(54) CONNECTING STRUCTURE OF FILTER AND LENS HOOD

(71) Applicant: SHENZHEN VELIUM PRECISION OPTICS CO., LTD., SHENZHEN (CN)

(72) Inventors: XI LIAO, CHENGDU (CN); WEIJIA LONG, SHENZHEN (CN)

(21) Appl. No.: 18/590,978

(22) Filed: Feb. 29, 2024

Related U.S. Application Data
(63) Continuation of application No. PCT/CN2022/114576, filed on Aug. 24, 2022.

(30) Foreign Application Priority Data
Aug. 30, 2021 (CN) 202122074939.0

(51) Int. Cl. G03B 17/12

(52) U.S. Cl. CPC G03B 17/12

(57) ABSTRACT

A connecting structure of a filter and a lens hood includes a filter holder and a lens hood holder. The lens hood holder is detachably connected with the filter holder. Two filter mounting pieces are symmetrically arranged on the filter holder. Limiting pieces are arranged on the filter mounting pieces. Each of the filter mounting pieces includes at least one limiting piece. The lens hood holder includes a holder body and adjusting pieces one-to-one corresponding to the limiting pieces. The adjusting pieces are rotatably connected with the holder body. The adjusting pieces are rotated to enable the adjusting pieces to one-to-one abut against the limiting pieces, so that the lens hood holder is fixedly connected with the filter holder. Therefore, the filter and the lens hood are allowed to be mounted on a camera at the same time.

### TECHNICAL FIELD

The present disclosure relates to a field of photographic equipment, and in particular to a connecting structure of a filter and a lens hood.

### BACKGROUND

A filter holder is configured to mount a filter on a camera, and a lens hood holder is configured to mount a lens hood on the camera. When the camera needs to use the filter and the lens hood at the same time, the filter holder is not connected with the lens hood holder, which is unable to meet needs of the camera to use the filter and the lens hood at the same time.

### SUMMARY

To solve above problem, the present disclosure provides a connecting structure of a filter and a lens hood.

The present disclosure provides the connecting structure of the filter and the lens hood. The connecting structure comprises a filter holder and a lens hood holder.

The lens hood holder is detachably connected with the filter holder. Two filter mounting pieces are symmetrically arranged on the filter holder. Limiting pieces are arranged on the filter mounting pieces. Each of the filter mounting pieces comprises at least one limiting piece. The lens hood holder comprises a holder body and adjusting pieces one-to-one corresponding to the limiting pieces. The adjusting pieces are rotatably connected with the holder body. The adjusting pieces are rotated to enable the adjusting pieces to one-to-one abut against the limiting pieces, so that the lens hood holder is fixedly connected with the filter holder.

Furthermore, the limiting pieces comprise first limiting portions and second limiting portions. The first limiting portions are fixedly connected with the filter mounting pieces. The second limiting portions one-to-one extend out of the filter mounting pieces. The adjusting pieces are rotated to enable the adjusting pieces to one-to-one abut against the second limiting portions.

Furthermore, the holder body comprises limiting holes one-to-one corresponding to the limiting pieces. When the lens hood holder is fixedly connected with the filter holder, the first limiting portions are one-to-one accommodated in the limiting holes and abut against side walls of the limiting holes.

Furthermore, the adjusting pieces comprise adjusting plates and limiting plates. The adjusting plates are rotated to enable the limiting plates to one-to-one abut against the second limiting portions.

Furthermore, the lens hood holder further comprises limiting columns one-to-one corresponding to the adjusting pieces. The limiting columns one-to-one pass through the adjusting pieces and extend into the holder body. The adjusting pieces are one-to-one movably connected with the limiting columns.

The connecting structure of the filter and the lens hood of the present disclosure enables the filter holder being fixedly connected with the lens hood holder, so that the filter and the lens hood are allowed to be mounted on a camera at the same time.

### BRIEF DESCRIPTION OF DRAWINGS

FIG. 1 is a perspective schematic diagram of a connecting structure of a filter holder and a lens hood holder of the present disclosure.

FIG. 2 is an enlarged schematic diagram of portion A shown in FIG. 1.

FIG. 3 is a perspective schematic diagram of a filter holder of the connecting structure of the filter and the lens hood of the present disclosure.

FIG. 4 is a perspective schematic diagram of a lens hood holder of the connecting structure of the filter and the lens hood of the present disclosure.

### DETAILED DESCRIPTION

In order to explain technical solution of the present disclosure clearly and completely, the present disclosure will be further described below in conjunction with the accompanying drawings.

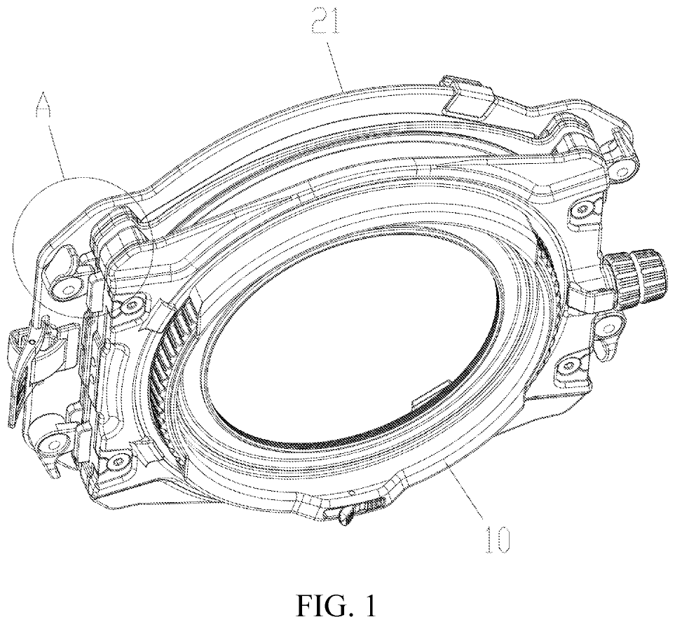

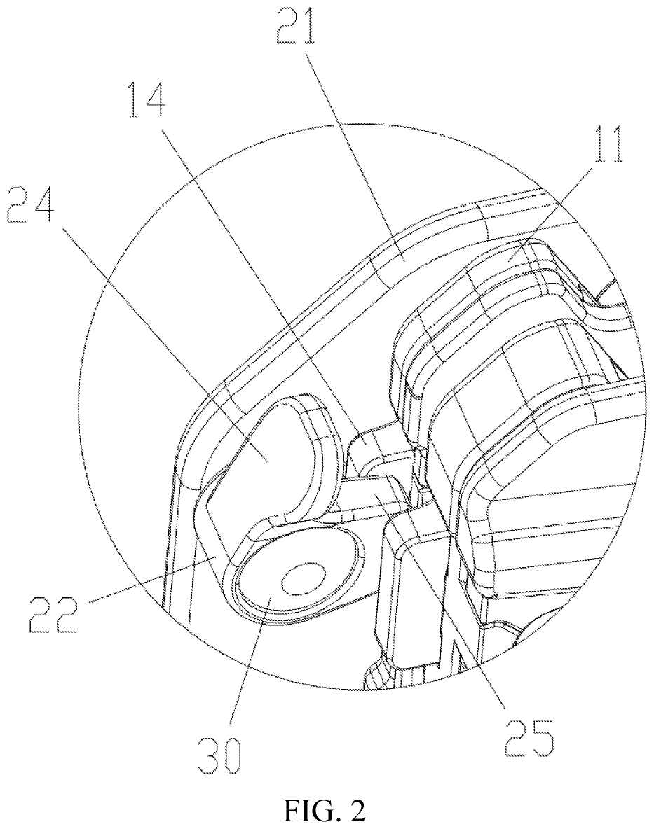

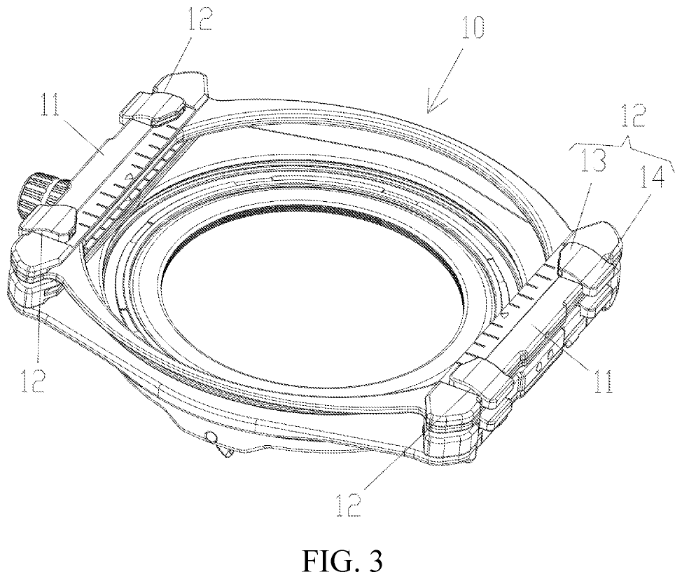

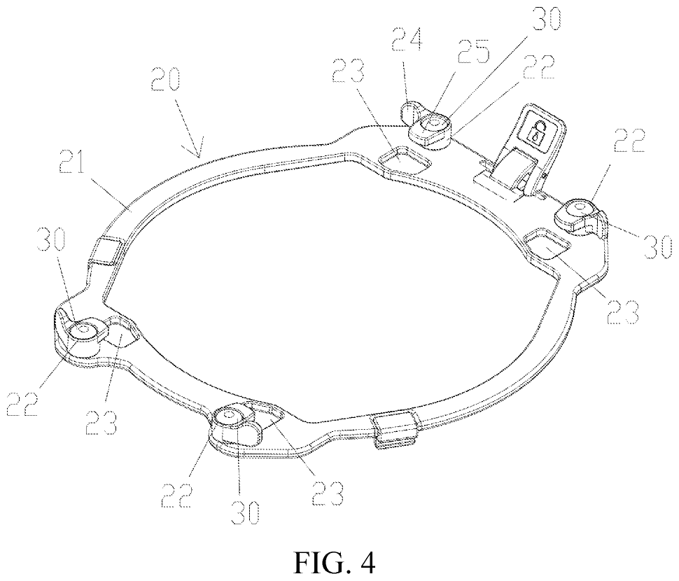

As shown in FIG. 1-4, the present disclosure provides a connecting structure of a filter holder and a lens hood holder. The connecting structure comprises a filter holder 10 and a lens hood holder 20. The lens hood holder 20 is detachably connected with the filter holder 10. Two filter mounting pieces 11 are symmetrically arranged on the filter holder 10. Each of the filter mounting pieces 11 comprises at least one limiting piece 12. The lens hood holder 20 comprises a holder body 21 and adjusting pieces 22 one-to-one corresponding to the limiting pieces 12. The adjusting pieces 22 are rotatably connected with the holder body 21. The adjusting pieces 22 are rotated to enable the adjusting pieces 22 to one-to-one abut against the limiting pieces 12, so that the lens hood holder 20 is fixedly connected with the filter holder 10.

In the embodiment, each of the filter mounting pieces 11 comprises two limiting pieces 12, and four adjusting pieces 22 are provided. The four adjusting pieces 22 are one-to-one corresponding to the four limiting pieces 12. The lens hood holder 20 is detachably connected with the filter holdert 10, and a user is able to mount the lens hood holder 20 on the filter holder 10 or detach the lens hood holder 20 from the filter holder 10 according to use requirements. When the lens hood holder 20 is mounted, the holder body 21 is first placed on the filter mounting pieces 11, and then the adjusting pieces 22 are rotated to enable the adjusting pieces 22 to one-to-one abut against the limiting pieces 12, so that the holder body 21 and the adjusting pieces 22 firmly clamp the filter mounting pieces 11, thus enabling the lens hood holder 20 being fixedly connected with the filter holder 10. The connecting structure of the filter and the lens hood enables the lens hood holder 20 and the filter holder 10 to form a fixed connection, so that a camera is allowed to mount the filter and the lens hood at the same time.

Furthermore, the limiting pieces 12 comprise first limiting portions 13 and second limiting portions 14. The first limiting portions 13 are fixedly connected with the filter mounting piece 11. The second limiting portions 14 one-to-one extend out of the filter mounting piece. The adjusting pieces 22 are rotated to enable the adjusting pieces 22 to one-to-one abut against the second limiting portions 14.

Furthermore, the holder body 21 comprises limiting holes 23 one-to-one corresponding to the limiting pieces 12. When the lens hood holder 20 is fixedly connected with the filter holder 10, the first limiting portions 13 are one-to-one accommodated in the limiting holes 23 and abut against side walls of the limiting holes 23.

In the embodiment, each of the first limiting portions 13 and a corresponding second limiting portion 14 are integrally formed. When mounting the lens hood holder 20, the holder body 21 is first placed on the filter mounting pieces 11, so that the first limiting portions 13 are one-to-one accommodated in the limiting holes 23 and abuts against the side walls of the limiting holes 23, then the adjusting pieces 22 are rotated to enable the adjusting pieces 22 to one-to-one abut against the second limiting portions 14, so that the holder body 21 and the adjusting pieces 22 firmly clamp the filter mounting pieces 11, thus enabling the lens hood holder 20 being fixedly connected with the filter holder 10.

In the embodiment, the first limiting portions 13 have functions of positioning and limiting. When mounting the lens hood holder 20, the first limiting portions 13 play a role in positioning, thereby facilitating the user to mount the lens hood holder 20. After the lens hood holder 20 is mounted, the first limiting portions 13 are one-to-one accommodated in the limiting holes 23 and abuts against the side walls of the limiting holes 23. The first limiting portions 13 play a limiting role to limit rotation of the lens hood holder 20 relative to the filter holder 10, so that connection between the lens hood holder 20 and the filter holder 10 is firm.

Furthermore, the adjusting pieces 22 comprise adjusting plates 24 and limiting plates 25. The adjusting plates 24 are rotated to enable the limiting plates 25 to one-to-one abut against the second limiting portions 14.

In the embodiment, the adjusting plates 24 facilitate the user to rotate the adjusting pieces 22. When the lens hood holder 20 is mounted, the holder body 21 is first placed on the filter mounting pieces 11, so that the first limiting portions 13 are one-to-one accommodated in the limiting holes 23 and abut against the side walls of the limiting holes 23, then the adjusting plates 24 are pressed to drive the adjusting pieces 22 to rotate, so that the limiting plates 25 one-to-one abut against the second limiting portions 14, and the holder body 21 and the limiting plates 25 firmly clamp the filter mounting pieces 11, thereby enabling the lens hood holder 20 being fixedly connected with the filter holder 10.

Furthermore, the lens hood holder 20 further comprises limiting columns 30 one-to-one corresponding to the adjusting pieces 22. The limiting columns 30 one-to-one pass through the adjusting pieces 22 and extend into the holder body 21. The adjusting pieces 22 are one-to-one movably connected with the limiting columns 30.

In the embodiment, four limiting columns 30 are provided. The limiting columns 30 are fixedly connected with the holder body 21. The adjusting pieces 22 are one-to-one movably connected with the limiting columns 30, so that the adjusting pieces 22 are movably connected with the holder body 21.

Of course, the present disclosure also has various other embodiments. Based on the embodiments mentioned above, other embodiments obtained by those of ordinary skill in the art without any creative work fall within the protection scope of the present disclosure.

What is claimed is:

1. A connecting structure of a filter and a lens hood, comprising:
a filter holder, and
a lens hood holder;
wherein the lens hood holder is detachably connected with the filter holder; two filter mounting pieces are symmetrically arranged on the filter holder; limiting pieces are arranged on the filter mounting pieces; each of the filter mounting pieces comprises at least one limiting piece; the lens hood holder comprises a holder body and adjusting pieces one-to-one corresponding to the limiting pieces; the adjusting pieces are rotatably connected with the holder body; the adjusting pieces are rotated to enable the adjusting pieces to one-to-one abut against the limiting pieces, so that the lens hood holder is fixedly connected with the filter holder.

2. The connecting structure according to claim 1, wherein the limiting pieces comprise first limiting portions and second limiting portions; the first limiting portions are fixedly connected with the filter mounting pieces; the second limiting portions one-to-one extend out of the filter mounting pieces; the adjusting pieces are rotated to enable the adjusting pieces to one-to-one abut against the second limiting portions.

3. The connecting structure according to claim 2, wherein the holder body comprises limiting holes one-to-one corresponding to the limiting pieces; when the lens hood holder is fixedly connected with the filter holder, the first limiting portions are one-to-one accommodated in the limiting holes and abut against side walls of the limiting holes.

4. The connecting structure according to claim 2, wherein the adjusting pieces comprise adjusting plates and limiting plates; the adjusting plates are rotated to enable the limiting plates to one-to-one abut against the second limiting portions.

5. The connecting structure according to claim 1, wherein the lens hood holder further comprises limiting columns one-to-one corresponding to the adjusting pieces; the limiting columns one-to-one pass through the adjusting pieces and extend into the holder body; the adjusting pieces are one-to-one movably connected with the limiting columns.
